(19) United States
(12) Patent Application Publication
(10) Pub. No.: US 2019/0036231 A1
(43) Pub. Date: Jan. 31, 2019

(54) ARRAY ANTENNA AND MOBILE TERMINAL

(71) Applicant: LG ELECTRONICS INC., Seoul (KR)

(72) Inventors: Seungwoo RYU, Seoul (KR); Joohee LEE, Seoul (KR)

(73) Assignee: LG ELECTRONICS INC., Seoul (KR)

(21) Appl. No.: 15/889,038

(22) Filed: Feb. 5, 2018

Related U.S. Application Data
(60) Provisional application No. 62/536,480, filed on Jul. 25, 2017.

(30) Foreign Application Priority Data
Oct. 17, 2017 (KR) 10-2017-0134805

(51) Int. Cl. H01Q 21/06; H01Q 1/24; H01Q 5/20; H01Q 5/307

(52) U.S. Cl. CPC H01Q 21/065; H01Q 5/307; H01Q 5/20; H01Q 1/242

(57) ABSTRACT

An array antenna includes a substrate, first radiation elements disposed at the substrate at equal intervals, second radiation elements disposed at the substrate at equal intervals, the second radiation elements being located between the first radiation elements, a first power supply unit located at the end of each first radiation element in a first direction for supplying power to the first radiation element, a second power supply unit located at the end of each first radiation element in a second direction, which is perpendicular to the first direction, for supplying power to the first radiation element, a third power supply unit located at the end of each second radiation element in a third direction for supplying power to the second radiation element, and a fourth power supply unit located at the end of each second radiation element in a fourth direction, which is perpendicular to the third direction.

### CROSS-REFERENCE TO RELATED APPLICATIONS

Pursuant to 35 U.S.C. § 119, this application claims the benefit of U.S. Provisional Application No. 62/536,480, filed on Jul. 25, 2017, and claims the benefit of earlier filing date and right of priority to Korean Patent Application No. 10-2017-0134805, filed on Oct. 17, 2017, the contents of which are all incorporated by reference herein in their entirety.

### BACKGROUND OF THE INVENTION

### Field of the Invention

The present invention relates to an array antenna for transmitting and receiving a millimeter wave used for fifth-generation mobile communication and a mobile terminal including the same.

### Discussion of the Related Art

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device.

As the result of diversifying the functions of the terminal, various kinds of wireless communication are applied to transmit and receive data in a wireless fashion. As the result of diversifying the multimedia functions, ultra-high-definition (UHD) quality video is watched or virtual reality (VR) content is used only through mobile communication. For this reason, technology enabling much more data to be transmitted and received more rapidly has been required.

Consequently, long-term evolution (LTE) communication (fourth-generation mobile communication), which enables a much larger amount of data to be rapidly transmitted and received, has been developed. Furthermore, the LTE communication has progressed to LTE-A and wide-band LTE, which provide at least double the previous transmission speed. In order to increase the transmission speed, two or more frequency bands are simultaneously used, or a frequency bandwidth is enlarged to increase the amount of data that is transmitted. In order to enlarge the frequency bandwidth or to simultaneously use signals in different frequency bands, the number of antennas must be increased.

There is a limitation on enlarging a frequency bandwidth or using a plurality of signals having different bands. For this reason, fifth-generation mobile communication technology has been developed. Fifth-generation mobile communication technology is advantageous in transmitting a large amount of data, and has a shorter response time than the conventional fourth-generation mobile communication technology. Since a signal having a higher frequency band than in fourth-generation mobile communication is used, an antenna having a different structure than the conventional antennas is needed.

### SUMMARY OF THE INVENTION

Accordingly, the present invention is directed to an array antenna and a mobile terminal that substantially obviate one or more problems due to limitations and disadvantages of the related art.

An object of the present invention is to provide an array antenna configured to transmit and receive a millimeter wave used for fifth-generation mobile communication within a limited area and a mobile terminal including the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an array antenna includes a substrate, a plurality of first radiation elements disposed at one surface of the substrate at equal intervals, a plurality of second radiation elements disposed at the one surface of the substrate at equal intervals, the second radiation elements being located between the first radiation elements, a first power supply unit located at the end of each first radiation element in a first direction for supplying power to the first radiation element, a second power supply unit located at the end of each first radiation element in a second direction, which is perpendicular to the first direction, for supplying power to the first radiation element, a third power supply unit located at the end of each second radiation element in a third direction for supplying power to the second radiation element, and a fourth power supply unit located at the end of each second radiation element in a fourth direction, which is perpendicular to the third direction, for supplying power to the second radiation element, wherein the first radiation elements are the same size, the second radiation elements are the same size and are smaller than the first radiation elements, and the third direction is inclined 45 degrees with respect to the first direction.

The direction of current supplied by the third power supply unit may be inclined 45 degrees with respect to the direction of current supplied by the first power supply unit.

The first to fourth power supply units may be maximally spaced apart from the center of the array antenna.

The first power supply units and the second power supply units, which supply power to the first radiation elements, may be disposed outside the array antenna in order to reduce interference between the first power supply unit and the second power supply unit located at one first radiation element and the first power supply unit and the second power supply unit located at another first radiation element, and the third power supply units and the fourth power supply units, which supply power to the second radiation elements, may be disposed outside the array antenna in order to reduce interference between the third power supply unit and the fourth power supply unit located at one second radiation element and the third power supply unit and the fourth power supply unit located at another second radiation element.

The number of first radiation elements disposed in the first direction may be three or more, and the first power supply units of the first radiation elements disposed in the first direction may be disposed in a line.

The first radiation elements and the second radiation elements may not overlap each other.

The number of first radiation elements disposed in the first direction may be equal to the number of first radiation elements disposed in the second direction.

The number of second radiation elements disposed in the third direction may be equal to the number of second radiation elements disposed in the fourth direction.

The number of second radiation elements may be greater than the number of first radiation elements.

The first radiation elements may be symmetrical with respect to the first power supply unit in the second direction and with respect to the second power supply unit in the first direction, and the second radiation elements may be symmetrical with respect to the third power supply unit in the fourth direction and with respect to the fourth power supply unit in the third direction.

The maximum length of the first radiation elements in the first direction may be equal to the maximum length of the first radiation elements in the second direction, and the maximum length of the second radiation elements in the third direction may be equal to the maximum length of the second radiation elements in the fourth direction.

The distance between the first radiation elements may be ½ to 1 times the wavelength of a first signal, and the distance between the second radiation elements may be ½ to 1 times the wavelength of a second signal.

The ratio of the distance between the first radiation elements to the distance between the second radiation elements may correspond to the ratio of the wavelength of the first signal to the wavelength of the second signal.

The array antenna may further include a plurality of third radiation elements located between the second radiation elements, the third radiation elements being disposed at equal intervals.

The substrate may have a dielectric constant of 0.3 or more.

In another aspect of the present invention, a mobile terminal includes a case, a display unit located at the front of the case, and an array antenna mounted in the case for transmitting and receiving a first signal and a second signal, wherein the array antenna includes a substrate, a plurality of first radiation elements disposed at the substrate at intervals of ½ the wavelength of the first signal, a plurality of second radiation elements located between the first radiation elements, the second radiation elements being disposed at equal intervals, a first power supply unit located at the end of each first radiation element in a first direction for supplying power to the first radiation element, a second power supply unit located at the end of each first radiation element in a second direction, which is perpendicular to the first direction, for supplying power to the first radiation element, a third power supply unit located at the end of each second radiation element in a third direction for supplying power to the second radiation element, and a fourth power supply unit located at the end of each second radiation element in a fourth direction, which is perpendicular to the third direction, for supplying power to the second radiation element, and wherein the first radiation elements are the same size, the second radiation elements are the same size and are smaller than the first radiation elements, and the third direction is inclined 45 degrees with respect to the first direction.

The first signal may have a band ranging from 26.5 to 29.5 GHz, and the second signal may have a band ranging from 37 to 40 GHz.

The array antenna may be disposed so as to face the rear of the case.

The first to fourth power supply units may be maximally spaced apart from the center of the array antenna.

The first radiation elements may be symmetrical with respect to the first power supply unit in the second direction and with respect to the second power supply unit in the first direction, the second radiation elements may be symmetrical with respect to the third power supply unit in the fourth direction and with respect to the fourth power supply unit in the third direction, the maximum length of the first radiation elements in the first direction may be equal to the maximum length of the first radiation elements in the second direction, and the maximum length of the second radiation elements in the third direction may be equal to the maximum length of the second radiation elements in the fourth direction.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1A is a block diagram of a mobile terminal in accordance with the present disclosure;

FIGS. 1B and 1C are conceptual views of one example of the mobile terminal, viewed from different directions;

FIG. 2 is a view illustrating the arrangement of radiation elements of an array antenna according to the present invention;

FIG. 3 is a view illustrating the performance of a mobile terminal according to the present invention that receives a signal transmitted by a base station based on the disposition thereof;

FIG. 4 is a view showing power supply units of the array antenna according to the present invention;

FIG. 5 is a view illustrating the angle by which the direction of a beam pattern is adjusted based on the distance between the radiation elements of the array antenna according to the present invention;

FIG. 6 is a view illustrating the disposition of the power supply units of the array antenna according to the present invention;

FIG. 7 is a view showing another embodiment of the array antenna according to the present invention; and

FIG. 8 is a view showing a further embodiment of the array antenna according to the present invention.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

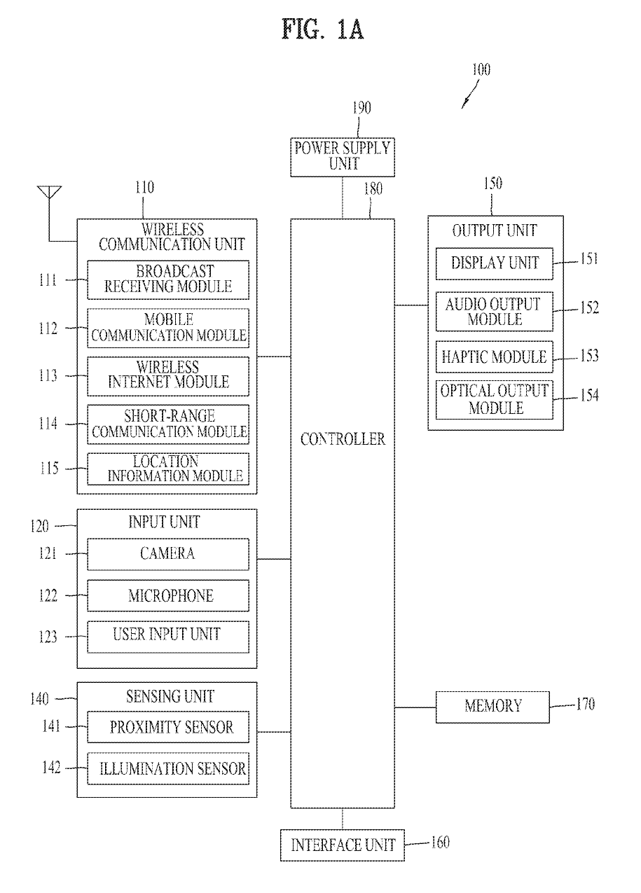

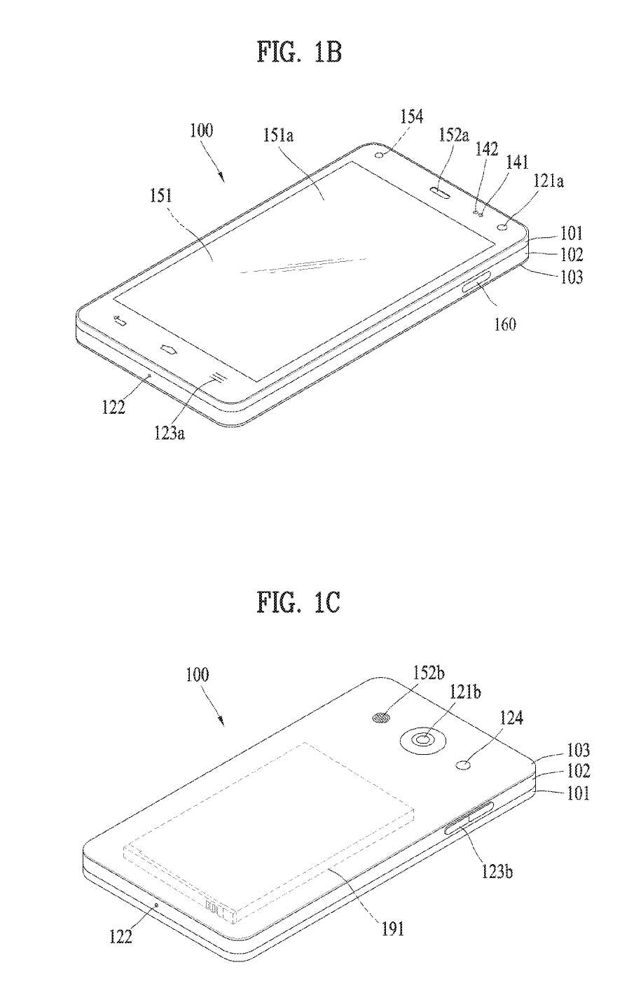

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components in FIG. 1A is not a requirement, and that greater or fewer components may alternatively be implemented.

More specifically, the wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, the sensing unit 140 may alternatively or additionally include other types of sensors or devices, such as a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output, or activating application programs stored in the memory 170.

To drive the application programs stored in the memory 170, the controller 180 may be implemented to control a predetermined number of the components mentioned above in reference with FIG. 1A. Moreover, the controller 180 may be implemented to combinedly operate two or more of the components provided in the mobile terminal 100 to drive the application programs.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Some or more of the components may be operated cooperatively to embody an operation, control or a control method of the mobile terminal in accordance with embodiments of the present disclosure. Also, the operation, control or control method of the mobile terminal may be realized on the mobile terminal by driving of one or more application problems stored in the memory 170.

Referring still to FIG. 1A, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), EV-DO(Enhanced Voice-Data Optimized or Enhanced Voice-Data Only), Wideband CDMA (WCDMA), High Speed Downlink Packet access (HSDPA), HSUPA(High Speed Uplink Packet Access), Long Term Evolution (LTE) , LTE-A(Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA(High Speed Uplink Packet Access), Long Term Evolution (LTE), LTE-A(Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA,HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 supplies power from an external power source or an internal power source to respective elements of the terminal under the control of the controller 180. The power supply unit 190 includes a battery. The battery may be an internal battery that is rechargeable. The battery may be coupled to the terminal body so as to be detached from the terminal body for recharging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

Here, the terminal body may be understood to refer to the concept of this bore a mobile terminal (100) to at least one of the aggregate.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In order to increase the rigidity of the mobile terminal 100, a middle frame may be provided to support the bottom surface of the display unit 151. The middle frame may include a metal material. The middle frame not only increases the rigidity of the mobile terminal but also serves as a ground having a large area including a conductive material. Consequently, the middle frame may be connected to the respective elements of the terminal so as to ground an electronic element, such as an antenna.

The middle frame may be configured not to be exposed outward. Alternatively, the middle frame may be integrally formed with the front case of the body or a side case of the body.

As the result of diversifying a multimedia function, the size of the display unit 151 becomes larger, whereas the size of a bezel located around the display unit 151 becomes smaller. However, there is a limitation on the extent to which the size of the display unit 151 can be increased, since the camera 121, the audio output module 152, and the proximity sensor 141 are located at the upper end of the terminal and physical buttons are located at the lower end of the terminal.

In recent years, the size of each element has been minimized, and the user input unit 123 has been configured using soft keys, rather than physical buttons. The soft keys are configured to appear as needed and disappear when not needed. As a result, the size of the screen is further increased.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal may include a display unit 151, first and second audio output modules 152a and 152b, a proximity sensor 141, an illumination sensor 142, an optical output module 154, first and second camera 121a and 121b, first and second manipulation units 123a and 123b, a microphone 122, and an interface unit 160.

It will be described for the mobile terminal as shown in FIGS. 1B and 1C. The display unit 151, the first audio output module 151a, the proximity sensor 141, an illumination sensor 142, the optical output module 154, the first camera 121a and the first manipulation unit 123a are arranged in front surface of the terminal body, the second manipulation unit 123b, the microphone 122 and interface unit 160 are arranged in side surface of the terminal body, and the second audio output modules 151b and the second camera 121b are arranged in rear surface of the terminal body.

It is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

A flash 124 is shown located adjacent to the second camera 121b. When an image of a subject is captured with the camera 121b, the flash 124 may illuminate the subject.

The second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 (see FIG. 1A) may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Hereinafter, embodiments of a control method that can be realized in the mobile terminal having the above structure will be described with reference to the accompanying drawings. It will be obvious to those skilled in the art that the present invention can be embodied into other specific forms without departing from the spirit and essential features of the present invention.

As the focus is placed on the multimedia function, wireless communication technology is performed in the mobile terminal 100 in various manners, such as short-distance communication, long-distance communication, and inter-device communication. Since different frequency bands (resonance frequencies) are used, different antennas or radiators must be used.

In order to support the transmission and reception of a large amount of data, fifth-generation mobile communication technology that is capable of rapidly transmitting and receiving a large amount of data using a millimeter wave, which is an ultrahigh frequency, has been developed, in addition to fourth-generation mobile communication technology (LTE). Fifth-generation mobile communication technology uses an ultrahigh frequency signal.

An antenna used in conventional mobile communication is an antenna having a radiation pattern in which an electromagnetic wave is radiated without directivity, such as a dipole antenna or a monopole antenna. In this case, however, a large amount of energy is used for signal transmission, whereby gain is reduced. If a beam-pattern radiation method of radiating a beam pattern from a transmission end to a reception end is used, mobile communication may be performed using a smaller amount of energy.

A plurality of radiation elements may be used to combine beam patterns of antennas, thereby realizing a sharp beam pattern. An array antenna using a plurality of radiation elements may make a beam pattern sharper such that a signal can be transmitted further away in a specific direction. Power supplied to the radiation elements may be controlled to adjust the direction of the beam pattern.

Fifth-generation mobile communication uses an ultrahigh frequency signal, since it is necessary to innovatively increase the capacity (1000 times the capacity of LTE). The size and disposition of the radiation elements of the antenna are dependent on the wavelength of a signal. If an ultrahigh frequency signal is used, therefore, it is possible to reduce the size of the radiation elements of the antenna. A frequency signal band used in fifth-generation mobile communication is 28 GHz or higher, which is higher than a high frequency band used in LTE communication, namely 2.5 GHz. Consequently, the wavelength is very short.

If an ultrahigh frequency band signal is used, the frequency band can be increased, thereby improving the performance of the antenna, since interference with other signals is low. In addition, it is possible to reduce the size of the radiation elements of the antenna for an ultrahigh frequency band signal, and when several small-sized radiation elements are arranged on a substrate made of an insulative material to constitute an array antenna 200 for forming a beam pattern, the performance of the antenna may be increased up to 10 times.

Omni-directional transmission causes energy consumption. If a beam pattern antenna is realized using the array antenna 200, energy consumption can be reduced. In fifth-generation mobile communication technology, an ultrahigh frequency band signal is transmitted and received through the array antenna 200.

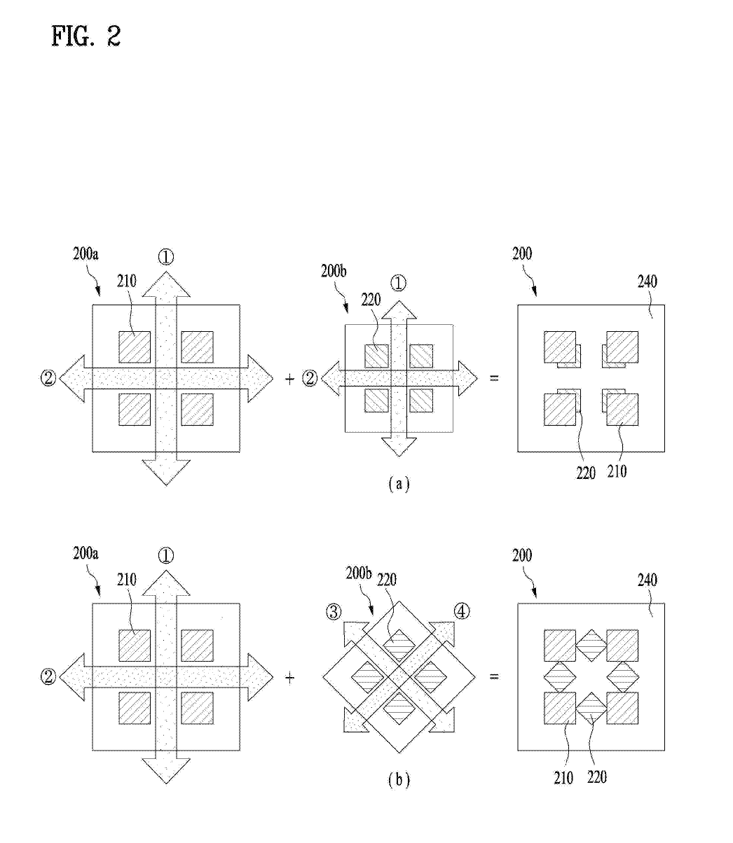

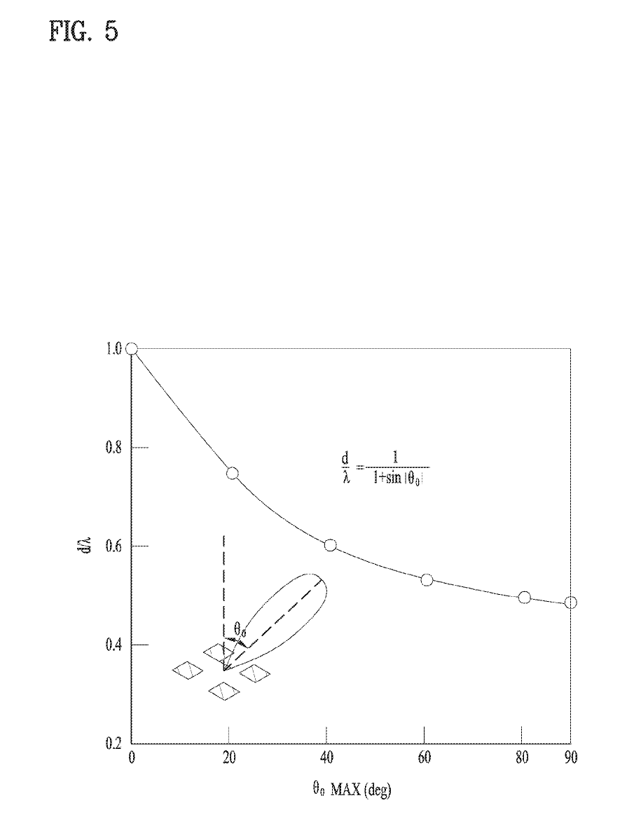

FIG. 2 is a view illustrating the arrangement of the radiation elements of the array antenna 200. The array antenna 200 used in fifth-generation communication uses radiation elements 210 and 220 arranged in a matrix form in a first direction \textcircled{1} and a second direction \textcircled{2}, which is perpendicular to the first direction \textcircled{1}. Basically, the radiation elements 210 and 220 are arranged in a 2×2 matrix. The power supplied to each radiation element is controlled to adjust the direction θ₀ of a beam (see FIG. 5).

The antenna is a device that transmits and receives an electromagnetic wave. The electromagnetic wave advances while having a waveform that vibrates in a specific direction. Such a vibrating direction is referred to as polarization. If the polarization of an electromagnetic wave transmitted by the transmission antenna and the polarization of an electromagnetic wave received by the reception antenna are perpendicular to each other, no signal is transmitted. Consequently, the antenna according to the present invention transmits a signal using an electromagnetic wave having polarization both in the first direction \textcircled{1} and in the second direction \textcircled{2}, whereby it is possible to prevent failure of transmission of a signal.

Even in fifth-generation mobile communication technology, a plurality of signals in different frequency bands may be used in the same manner as in LTE mobile communication technology. For example, signals of 28 GHz and 39 GHz may be used. In order to transmit and receive the respective signals, separate array antennas 200a and 200b must be provided. As the number of the frequency bands used in mobile terminal is increased, the number of array antennas is increased. As a result, the area occupied by the radiation elements in the mobile terminal 100 is increased. In order to reduce the area occupied by the array antenna 200, a plurality of array antennas 200a and 200b may be disposed on a single substrate 240 in an overlapping fashion.

However, if the first radiation elements 210 of the first array antenna 200a and the second radiation elements 220 of the second array antenna 200b are arranged in a matrix form in the first direction \textcircled{1} and the second direction \textcircled{2}, the first radiation elements 210 and the second radiation elements 220 may overlap, as shown in FIG. 2(a). Even if the radiation elements are separately disposed on opposite surfaces of the substrate 240 such that the first radiation elements 210 and the second radiation elements 220 do not overlap each other, the polarization direction of the first array antenna 200a and the polarization direction of the second array antenna 200b overlap, whereby signals transmitted and received by the respective array antennas 200a and 200b interfere with each other.

In order to solve this problem, the array antenna 200 is configured such that the polarization direction of the first array antenna 200a and the polarization direction of the second array antenna 200b are inclined 45 degrees with respect to each other, as shown in FIG. 2(b). As a result, the polarization directions of the respective array antennas 200a and 200b do not overlap each other, whereby interference therebetween is reduced. In addition, the second radiation elements 220 are disposed between the first radiation elements 210 so as not to overlap each other. Consequently, it is possible to reduce the space in which the array antenna 200 is mounted. The second radiation elements 220 are disposed in a 2×2 matrix in a third direction \textcircled{3} and a fourth direction \textcircled{4}, which are inclined 45 degrees with respect to the first direction \textcircled{1} and the second direction \textcircled{2}, respectively.

Since the second radiation elements 220 of the second array antenna 200b are disposed between the first radiation elements 210 of the first array antenna 200a, overlapping between the first radiation elements 210 and the second radiation elements 220 is prevented even when the first radiation elements 210 and the second radiation elements 220 are disposed on the same surface of the substrate 240. In addition, the polarization direction of the first array antenna 200a and the polarization direction of the second array antenna 200b are inclined 45 degrees with respect to each other, whereby interference therebetween is reduced.

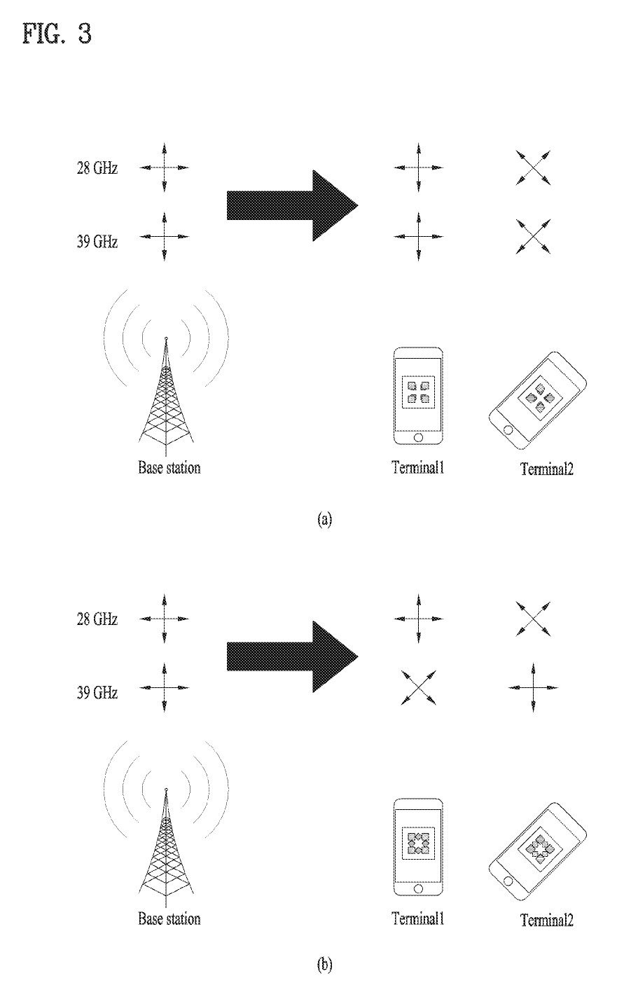

FIG. 3 is a view illustrating the performance of the mobile terminal that receives a signal transmitted by a base station based on the disposition of the array antenna 200 of FIG. 2. When the first radiation elements 210 and the second radiation elements 220 are disposed such that the first array antenna 200a and the second array antenna 200b have the same polarization direction, as shown in FIG. 2(a), the performance of the mobile terminal is satisfactory if the mobile terminal is disposed so as to be aligned with the polarization direction of a signal transmitted by the base station. If the mobile terminal is disposed so as to be inclined with respect to the polarization direction of a signal transmitted by the base station, particularly at 45 degrees relative thereto, however, the performance of the mobile terminal is reduced to the lowest. (See FIG. 3(a)).

When the first radiation elements 210 and the second radiation elements 220 are disposed such that the polarization direction of the second radiation elements 220 is inclined 45 degrees with respect to the polarization direction of the first radiation elements 210, as shown in FIG. 2(b), the polarization direction of one of the first and second radiation elements matches the direction of at least one of a 28 GHz signal or a 38 GHz signal, thereby maintaining wireless communication performance irrespective of the direction in which the mobile terminal is disposed.(See FIG. 3(b)).

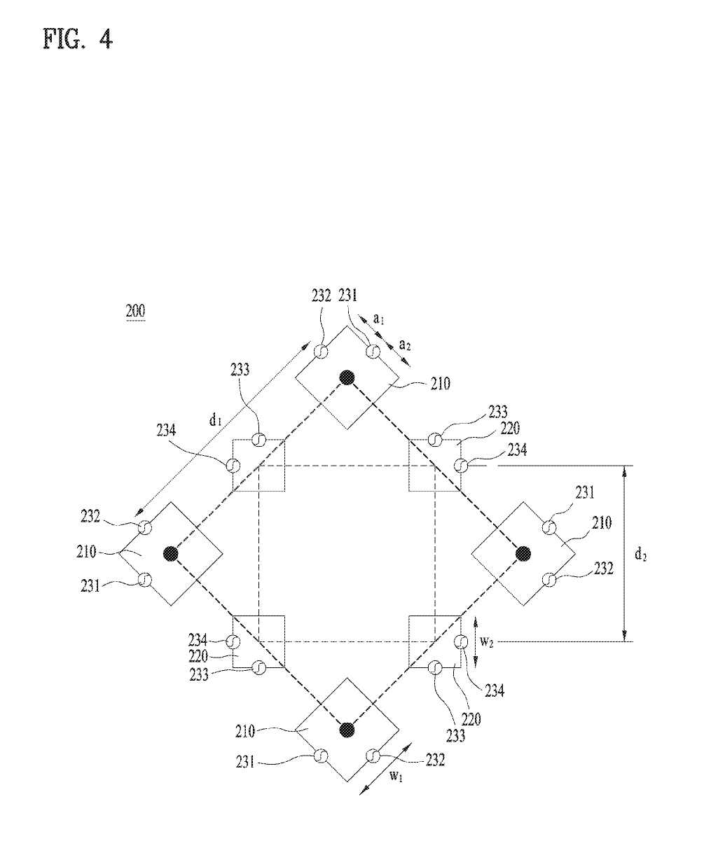

FIG. 4 is a view showing the radiation elements 210 and 220 and power supply units 231, 232, 233, and 234 of the array antenna 200 according to the present invention. The distance between the radiation elements 210 and 220 is set based on the wavelength of a resonance frequency. For a high frequency, therefore, the distance between the radiation elements is further decreased.

FIG. 5 is a view illustrating the angle by which the direction of a beam pattern is adjusted based on the distance between the radiation elements of the array antenna 200 according to the present invention. If the distance between the radiation elements is equal to the wavelength of a resonance frequency

$$( \frac{d}{λ} = 1 ) ,$$

it is not possible to change the direction of the beam pattern (θₘₐₓ=0). If the distance between the radiation elements is half the wavelength of the resonance frequency

$$( \frac{d}{λ} = 0.5 ) ,$$

it is possible to change the direction of the beam pattern up to 90 degrees (θₘₐₓ=90 degrees).

That is, the distance between the radiation elements may be set to between 0.5 to 1 times the wavelength of a signal that is transmitted and received. In order to maximize the range within which the direction of the beam pattern is adjustable, the distance between the radiation elements may be set to 0.5 times the wavelength of a first signal (0.5 λ) Since an accurate length is adjusted based on the dielectric constant of the substrate and the dielectric constant of the substrate is greater than that of a vacuum, however, the actual distance between the radiation elements is 0.5 λ or less.

The ratio of the distance between the first radiation elements 210 to the distance between the second radiation elements 220 is proportional to the reciprocal of a resonance frequency. In the case in which the resonance frequency of the first radiation elements 210 is 28 GHz and the resonance frequency of the second radiation elements 220 is 39 GHz, therefore, d₁:d₂=39:28. Consequently, d₁ is about 1.4 times d₂. The first radiation elements 210 and the second radiation elements 220 are disposed so as to be inclined 45 degrees with respect to each other. As shown in FIG. 4, therefore, the second radiation elements 220 may be disposed between the first radiation elements 210 (d₁≈d₂\sqrt{2}). The size of the radiation elements is also proportional to the resonance frequency. Consequently, w₁:w₂=1/4:1. The ratio of the wavelength of the first signal to the second signal used by the array antenna 200 having the above structure may be \sqrt{2:1}.

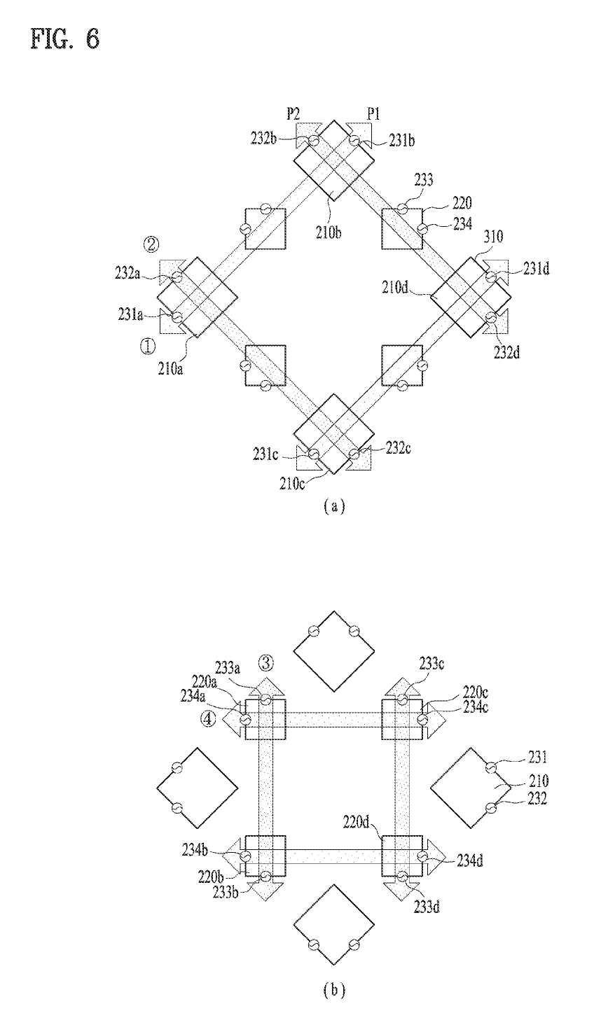

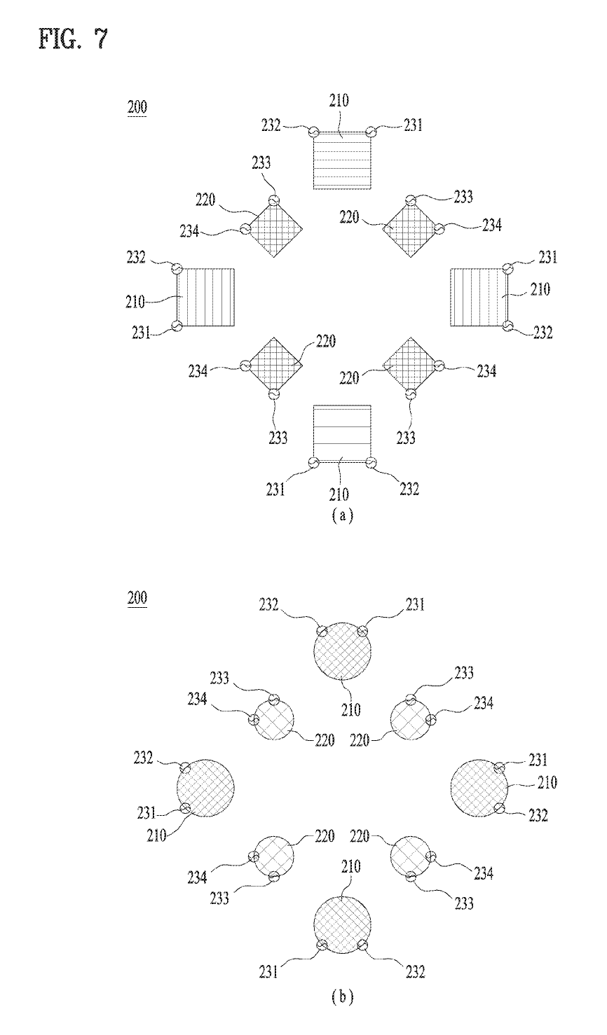

FIG. 6 is a view illustrating the disposition of the power supply units of the array antenna 200 according to the present invention, and FIG. 7 is a view showing another embodiment of the array antenna 200 according to the present invention.

The polarization direction of an electromagnetic wave transmitted by the array antenna 200 is set based on the position of the power supply units that supply power to the radiation elements. Two power supply units are provided for each radiation element in order to form polarization in perpendicular directions. The polarization direction is set based on the disposition of the power supply units. The power supply units of one radiation element and the power supply units of an adjacent radiation element are disposed side by side.

Referring to FIG. 6(a), first power supply units 231a and 231b of first radiation elements 210a and 210b, which are disposed side by side in the first direction \textcircled{1}, are also disposed side by side in the first direction \textcircled{1}, and second power supply units 232a and 232c of first radiation elements 210a and 210c, which are disposed side by side in the second direction \textcircled{2}, are also disposed side by side in the second direction \textcircled{2}. That is, the disposition of the power supply units corresponds to the disposition of the radiation elements.

Since power supplied from the power supply units flows along the radiation elements, the power supply units are disposed at the ends of the radiation elements. Since the first power supply units 231a and 231a or 231c and 231d are disposed side by side in the first direction \textcircled{1}, current flows in the first direction \textcircled{1}. Since the second power supply units 232a and 232c or 232b and 232d are disposed side by side in the second direction \textcircled{2}, current flows in the second direction \textcircled{2}.

The first radiation elements 210a to 210d are symmetrical with respect to the first power supply units 231a to 231d in the second direction \textcircled{2}, which is perpendicular to the first direction \textcircled{1}, and are symmetrical with respect to the second power supply units 232a to 232d in the first direction \textcircled{1}. If the first power supply units 231a to 231d or the second power supply units 232a to 232d are biased, the polarization direction formed by the first power supply units 231a to 231d may deviate. Also, in the case in which the maximum length of the first radiation elements 210a to 210d in the first direction \textcircled{1} and the maximum length of the first radiation elements 210a to 210d in the second direction \textcircled{2} are equal to each other, it is easy to control the polarization direction. Consequently, each of the first radiation elements 210 may be made of a diamond-shaped (square) or circular conductive patch (see FIG. 7(b)).

In the embodiment of FIG. 6(a), the first radiation elements 210 may be disposed in the state of deviating 45 degrees such that the first radiation elements 210 have the maximum length in the first direction \textcircled{1} and the second direction \textcircled{2}, as shown in FIG. 7(a). The same is true of third power supply units and fourth power supply units 234 of the second radiation elements 220. Consequently, the second radiation elements 220 are symmetrical in the third direction \textcircled{3} and the fourth direction \textcircled{4}, and each of the second radiation elements 220 has a square or circular structure.

A first power supply unit 231a to 231d is located at the end of each first radiation element 210a to 210d in the first direction \textcircled{1} and at the middle of each first radiation element 210a to 210d in the second direction \textcircled{2} (a₁=a₂, see FIG. 4). At this time, the first power supply units 231a to 231d may be located at one of the inside and the outside of the first radiation elements 210a to 210d. In order to minimize interference between the power supply units 231a to 231d and 232a to 232d, the first power supply units 231a to 231d may be located at the outside of the first radiation element 210a to 210d. A second power supply unit 232a to 232d may be located at the end of each first radiation element 210a to 210d in the second direction \textcircled{2}, may be located at the middle of each first radiation element 210a to 210d in the first direction \textcircled{1}, and may be disposed at the outside of the first radiation element 210a to 210d.

Referring to FIG. 6(b), a third power supply unit 233a and 233b or 233c and 233d may be located at the end of each second radiation element 220a to 220d in the third direction \textcircled{3} and at the middle of each second radiation element 220a to 220d in the fourth direction \textcircled{4}, and a fourth power supply unit 234a and 234c or 234b and 234d may also be located at the end of each second radiation element 220a to 220d in the fourth direction \textcircled{4} and at the middle of each second radiation element 220a to 220d in the third direction \textcircled{3}. The third power supply unit 233a to 233d and the fourth power supply unit 234a to 234d may be disposed at the outside of the second radiation element 220 in order to minimize interference therebetween.

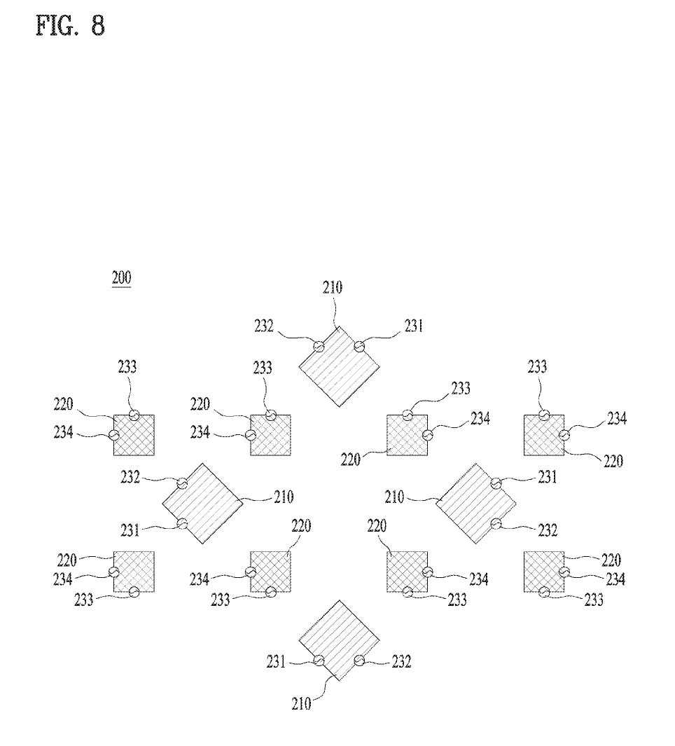

FIG. 8 is a view showing a further embodiment of the array antenna 200 according to the present invention. Since second radiation elements 220 transmit and receive a higher-frequency signal than first radiation elements 210, gain is reduced. In order to compensate for the reduction of gain, the number of second radiation elements 220 may be greater than the number of first radiation elements 210. Additional second radiation elements 220 are disposed so as to be spaced apart from the existing second radiation elements 220 by a distance corresponding to d₂ in the third direction or the fourth direction \textcircled{4}. Third power supply units 233 and fourth power supply units 234 of the additional second radiation elements 220 may be disposed outside according to the above rule.

In the above description, the two array antennas are disposed in an overlapping fashion. Alternatively, third radiation elements of the array antenna for transmitting and receiving a higher-frequency signal or a lower-frequency signal may be further disposed.

The array antenna 200 according to the present invention may be mounted in the mobile terminal shown in FIG. 1C. Since the display unit 151 is disposed at the front of the mobile terminal and the display unit 151 includes a conductive material, the array antenna may be disposed at the rear of the mobile terminal such that a beam pattern is emitted through the rear of the mobile terminal.

As is apparent from the above description, in the array antenna 200 according to the present invention, two more antennas supporting different frequency bands are realized within a limited area, whereby the space in which the array antenna is mounted is reduced.

The above detailed description is not to be construed as limiting the present invention in any aspect, and is to be considered by way of example. The scope of the present invention should be determined by reasonable interpretation of the accompanying claims, and all equivalent modifications made without departing from the present invention should be included in the following claims.

What is claimed is:

1. An array antenna comprising:
a substrate;
a plurality of first radiation elements disposed at one surface of the substrate at a first interval;
a plurality of second radiation elements disposed at the one surface of the substrate at a second interval such that each of the second radiation elements is located between two radiation elements of the plurality of first radiation elements;
a plurality of first power supply units, each of the plurality of first power supply units located at a first end of a respectively corresponding one of the plurality of first radiation elements such that the plurality of first power supply units are arranged in a first direction for supplying power to the plurality of first radiation elements;
a plurality of second power supply units, each of the plurality of second power supply units located at a second end of a respectively corresponding one of the plurality of first radiation elements such that the plurality of second power supply units are arranged in a second direction, which is perpendicular to the first direction, for supplying power to the plurality of first radiation elements;
a plurality of third power supply units, each of the plurality of third power supply units located at a first end of a respectively corresponding one of the plurality of second radiation elements such that the plurality of third power supply units are arranged in a third direction for supplying power to the plurality of second radiation elements; and
a plurality of fourth power supply units, each of the plurality of fourth power supply units located at a second end of a respectively corresponding one of the plurality of second radiation elements such that the plurality of fourth power supply units are arranged in a fourth direction, which is perpendicular to the third direction, for supplying power to the plurality of second radiation elements,
wherein:
each of the plurality of first radiation elements has a first size;
each of the plurality of second radiation elements has a second size that is smaller than the first size; and
the third direction is inclined 45 degrees with respect to the first direction.

2. The array antenna according to claim 1, wherein a direction of current supplied by the third power supply unit is inclined 45 degrees with respect to a direction of current supplied by the first power supply unit.

3. The array antenna according to claim 1, wherein each of the first to fourth power supply units is maximally spaced apart from a center of the substrate.

4. The array antenna according to claim 3, wherein:
the plurality of first power supply units and the plurality of second power supply units, which supply power to the plurality of first radiation elements, are disposed outside the plurality of first radiation elements such that interference between the first power supply unit and the second power supply unit located at the respectively corresponding one first radiation element and the first power supply unit and the second power supply unit located at another respectively corresponding first radiation element is reduced; and
the plurality of third power supply units and the plurality of fourth power supply units, which supply power to the second radiation elements, are disposed outside the plurality of second radiation elements such that interference between the third power supply unit and the fourth power supply unit located at the respectively corresponding one second radiation element and the third power supply unit and the fourth power supply unit located at another respectively corresponding second radiation element is reduced.

5. The array antenna according to claim 1, wherein:
a number of first radiation elements arranged in the first direction is at least three; and
the first power supply units of the first radiation elements arranged in the first direction are arranged along a straight line formed in the first direction.

6. The array antenna according to claim 1, wherein the plurality of first radiation elements and the plurality of second radiation elements do not overlap each other.

7. The array antenna according to claim 1, wherein a number of first radiation elements arranged in the first direction is equal to a number of first radiation elements arranged in the second direction.

8. The array antenna according to claim 1, wherein a number of second radiation elements arranged in the third direction is equal to a number of second radiation elements arranged in the fourth direction.

9. The array antenna according to claim 1, wherein a number of the plurality of second radiation elements is greater than a number of the plurality of first radiation elements.

10. The array antenna according to claim 1, wherein:
the plurality of first radiation elements are symmetrical with respect to the first power supply units arranged in the second direction and with respect to the second power supply units arranged in the first direction; and
the plurality of second radiation elements are symmetrical with respect to the third power supply units arranged in the fourth direction and with respect to the fourth power supply units arranged in the third direction.

11. The array antenna according to claim 10, wherein:
a distance between the first radiation elements arranged in the first direction is equal to a distance between the first radiation elements arranged in the second direction; and
a distance between the second radiation elements arranged in the third direction is equal to a distance between the second radiation elements arranged in the fourth direction.

12. The array antenna according to claim 1, wherein:
the first interval (d₁) is ½ to 1 times a wavelength of a first signal, and the second interval (d₂) is ½ to 1 times a wavelength of a second signal.

13. The array antenna according to claim 12, wherein a ratio of the first interval (d₁) to the second interval (d₂) corresponds to a ratio of the wavelength of the first signal to the wavelength of the second signal.

14. The array antenna according to claim 1, further comprising a plurality of third radiation elements located between the second radiation elements, the third radiation elements being disposed at a third interval.

15. The array antenna according to claim 1, wherein the substrate has a dielectric constant of at least 0.3.

16. A mobile terminal comprising:
a case;
a display located at a front surface of the case; and
an array antenna mounted in the case for transmitting and receiving a first signal and a second signal,
wherein the array antenna comprises:
a substrate;
a plurality of first radiation elements disposed at one surface of the substrate at a first interval;
a plurality of second radiation elements disposed at the one surface of the substrate at a second interval such that each of the plurality of second radiation elements is located between two radiation elements of the plurality of first radiation elements;
a plurality of first power supply units, each of the plurality of first power supply units located at a first end of a respectively corresponding one of the plurality of first radiation elements such that the plurality of first power supply units are in a first direction for supplying power to the plurality of first radiation elements;
a plurality of second power supply units, each of the plurality of second power supply units located at a second end of a respectively corresponding one of the plurality of first radiation elements such that the plurality of second power supply units are arranged in a second direction, which is perpendicular to the first direction, for supplying power to the plurality of first radiation elements;
a plurality of third power supply units, each of the plurality of third power supply units located at a first end of a respectively corresponding one of the plurality of second radiation elements such that the plurality of third power supply units are arranged in a third direction for supplying power to the plurality of second radiation elements; and
a plurality of fourth power supply units, each of the plurality of fourth power supply units located at a second end of a respectively corresponding one of the plurality of second radiation element such that the plurality of fourth power supply units are arranged in a fourth direction, which is perpendicular to the third direction, for supplying power to the plurality of second radiation elements, and
wherein:
each of the plurality of first radiation elements has a first size;
each of the plurality of second radiation elements has a second size that is smaller than the first size; and
the third direction is inclined 45 degrees with respect to the first direction.

17. The mobile terminal according to claim 16, wherein the first signal has a band ranging from 26.5 to 29.5 GHz, and the second signal has a band ranging from 37 to 40 GHz.

18. The mobile terminal according to claim 16, wherein the array antenna is disposed so as to face a rear surface of the case.

19. The mobile terminal according to claim 16, wherein each of the first to fourth power supply units is maximally spaced apart from a center of the substrate.

20. The mobile terminal according to claim 16, wherein:
the plurality of first radiation elements are symmetrical with respect to the first power supply units arranged in the second direction and with respect to the second power supply units arranged in the first direction;
the plurality of second radiation elements are symmetrical with respect to the third power supply units arranged in the fourth direction and with respect to the fourth power supply units arranged in the third direction;
a distance between the first radiation elements arranged in the first direction is equal to a distance between the first radiation elements arranged in the second direction; and
a distance between the second radiation elements arranged in the third direction is equal to a distance between the second radiation elements arranged in the fourth direction.
